(19) United States
(12) Patent Application Publication
(10) Pub. No.: US 2026/0057277 A1
(43) Pub. Date: Feb. 26, 2026

(54) OPTIMIZATION DEVICE, OPTIMIZATION METHOD, AND PROGRAM

(71) Applicant: TOHOKU UNIVERSITY, Sendai-shi, Miyagi (JP)

(72) Inventors: Takahiro HANYU, Sendai-shi (JP); Naoya ONIZAWA, Sendai-shi (JP); Ryoma SASAKI, Sendai-shi (JP)

(21) Appl. No.: 19/103,060

(22) PCT Filed: Jul. 4, 2023
(86) PCT No.: PCT/JP2023/024802

§ 371 Date: Feb. 11, 2025

(30) Foreign Application Priority Data
Aug. 16, 2022 (JP) 2022-129728

(51) Int. Cl. G06N 10/60

(52) U.S. Cl. CPC G06N 10/60

(57) ABSTRACT

An aspect of the invention includes an optimization unit configured to perform optimization, by stochastic calculation, on a Hamiltonian of a quantum annealing model, which is an Ising model representing the optimization target in a state in which a transverse magnetic field is applied, in which the optimization unit performs the optimization by executing a series of formulas satisfying a state update condition, which is a condition related to an update of a spin state, until a predetermined end condition is satisfied, and the state update condition includes a first condition representing the spin state, a second condition representing a relationship between the spin states obtained at different times, a third condition representing a relationship between adjacent trotter layers, and a fourth condition including an amount representing an intensity of an interaction between the same or different spins existing in the same trotter layer, an amount representing a magnitude of energy of a spin itself, and an amount representing an intensity of an interaction between spins belonging to different trotter layers.

### CROSS-REFERENCE TO RELATED APPLICATIONS

This application is the U.S. National Stage entry of International Application No. PCT/JP2023/024802, filed on Jul. 4, 2023, which, in turn, claims priority to Japanese Patent Application No. 2022-129728, filed on Aug. 16, 2022, both of which is are hereby incorporated herein by reference in their entireties for all purposes.

### TECHNICAL FIELD

The present invention relates to an optimization device, an optimization method, and a program.

### BACKGROUND ART

Optimization techniques are required in modern society in many situations, such as in pharmaceuticals and improvement of traffic congestion.

### CITATION LIST

### Non Patent Literature

NPL 1: Kenneth M. Zick, Omar Shehab, and Matthew French “Experimental quantum annealing: case study involving the graph isomorphism problem”, Scientific Reports, 5:11168, DOI: 10.1038/srep11168 (2015)

### SUMMARY OF INVENTION

### Technical Problem

However, in order to execute optimization in terms of calculation time and hardware implementation, a cost is often high. A cost is specifically time or expense, and the expense is specifically expense required for mounting a device and operating a device. As one of the techniques for solving such a problem, a quantum annealing technique has been proposed. It is known that if the quantum annealing technique is used, the calculation time can be significantly reduced. However, in the quantum annealing technique, it is often difficult to prepare an environment in which the device appropriately operates.

Therefore, there is an increasing expectation for improving an optimization technique by a classical computer. That is, there is an increasing expectation for a technique for reducing a cost required for optimization by a classical computer.

In view of the above circumstances, an object of the invention is to provide a technique for reducing a cost required for optimization by a classical computer.

### Solution to Problem

An aspect of the invention is an optimization device including an optimization unit configured to perform optimization, by stochastic calculation, on an optimization target by performing optimization on a Hamiltonian of a quantum annealing model, which is an Ising model representing the optimization target in a state in which a transverse magnetic field is applied. The optimization unit performs the optimization by sequentially executing a series of formulas satisfying a state update condition, which is a condition related to an update of a spin state, one by one by the stochastic calculation until a predetermined end condition is satisfied, and the state update condition includes a first condition representing the spin state, a second condition representing a relationship between the spin states obtained at different times, a third condition representing a relationship between adjacent trotter layers, and a fourth including an amount representing an intensity of an interaction between the same or different spins existing in the same trotter layer, an amount representing a magnitude of energy of a spin itself, and an amount representing an intensity of an interaction between spins belonging to different trotter layers.

An aspect of the invention is an optimization method includes an optimization step of performing optimization on an optimization target by performing optimization on a Hamiltonian of a quantum annealing model, which is an Ising model representing the optimization target in a state in which a transverse magnetic field is applied, by stochastic calculation. In the optimization step, the optimization is performed by sequentially executing a series of formulas satisfying a state update condition, which is a condition related to an update of a spin state, one by one by the stochastic calculation until a predetermined end condition is satisfied, and the state update condition includes a first condition representing the spin state, a second condition representing relationship between the spin states obtained at different times, a third condition representing a relationship between adjacent trotter layers, and a fourth condition including an amount representing an intensity of an interaction between the same or different spins existing in the same trotter layer, an amount representing a magnitude of energy of a spin itself, and an amount representing an intensity of an interaction between spins belonging to different trotter layers.

An aspect of the invention is a program configured to cause a computer to function as the above optimization device.

### Advantageous Effects of Invention

According to the invention, a cost required for optimization by a classical computer can be reduced.

### BRIEF DESCRIPTION OF DRAWINGS

FIG. 1 is a diagram showing an optimization device according to an embodiment.

FIG. 2 is a diagram showing an example of an FSM according to the embodiment.

FIG. 3 is a diagram showing an example of a hardware configuration of the optimization device according to the embodiment.

FIG. 4 is a diagram showing an example of a configuration of a control unit included in the optimization device according to the embodiment.

FIG. 5 is a flowchart showing an example of a flow of processing executed by the optimization device according to the embodiment.

FIG. 6 is a diagram showing an example of an Ising model according to the embodiment.

FIG. 7 is a diagram showing an example of a result of an experiment using the optimization device according to the embodiment.

FIG. 8 is a diagram showing a coefficient J_{i,j} used in an experiment in the embodiment.

FIG. 9 is a diagram showing an example of a coefficient hᵢ used in an experiment in the embodiment.

### DESCRIPTION OF EMBODIMENTS

### Embodiment

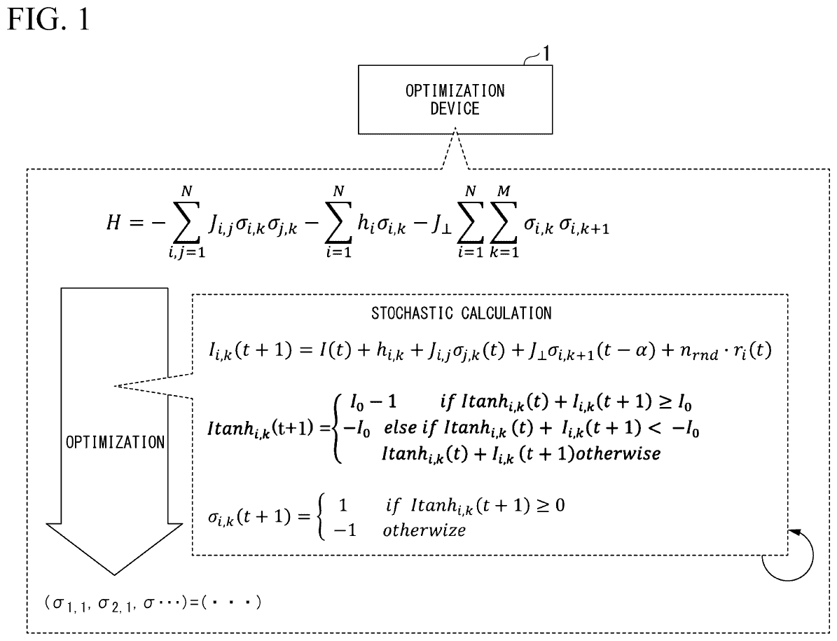

FIG. 1 is a diagram showing an optimization device 1 according to an embodiment. The optimization device 1 performs optimization on an optimization target represented by an Ising model by stochastic calculation. More specifically, the optimization device 1 performs the optimization on the optimization target by performing optimization on a Hamiltonian of a transverse magnetic field Ising model, which is a model when a transverse magnetic field is applied to the Ising model representing the optimization target, by the stochastic calculation. The optimization target means a target of the optimization. The model when the transverse magnetic field is applied to the Ising model representing the optimization target is the Ising model representing the optimization target in a state in which the transverse magnetic field is applied.

Hereinafter, the Ising model representing the optimization target in the state in which the transverse magnetic field is applied is referred to as a quantum annealing model. The Hamiltonian of the quantum annealing model is represented by, for example, the following Formula (1).

$$\begin{matrix}[ Math . 1 ] & \\ H = - {{\sum }^{N}}_{i , j = 1} {J}_{i , j} {σ}_{i , k} {σ}_{j , k} - {\sum }_{i = 1}^{N} {h}_{i} {σ}_{i , k} - {J}_{⊥} {\sum }_{i = 1}^{N} {\sum }_{k = 1}^{M} {σ}_{i , k} {σ}_{i , k + 1} & ( 1 )\end{matrix}$$

In Formula (1), σ represents a spin operator. When the stochastic calculation is executed, σ is a stochastic number representing an eigenvalue of the spin operator. The eigenvalue of the spin operator is +1 or −1. For example, stochastic number=1 represents a state of +1 of a spin, and stochastic number=0 represents a state of −1 of the spin.

A variable k represents a trotter layer number (that is, a position on a trotter axis). Both a variable i and a variable j are identifiers for distinguishing spins existing in the same trotter layer. Hereinafter, k is referred to as a trotter layer number. Hereinafter, the variable i and the variable j are referred to as spin numbers. That is, the spin number is an identifier for distinguishing spins existing in the same trotter layer. The variables i and j may be the same or different. When i and j are the same, a spin indicated by the variable i and a spin indicated by the variable j are the same spin.

N indicates the number of spins existing in one trotter layer in the quantum annealing model. Therefore, N is an integer of 1 or more. The number of spins included in one trotter layer is the same regardless of the trotter layer. M is the number of trotters. Therefore, M is a predetermined number. Each of the spin numbers i and j is an integer of 1 or more and N or less. The trotter layer number k is an integer of 1 or more and M or less.

A coefficient J_{i,j} is an amount representing an intensity of an interaction between the spin of the spin number i and the spin of the spin number j existing in the same trotter layer. More specifically, the coefficient J_{i,j} is an amount representing the intensity of the interaction between the same or different spins existing in the trotter layer whose trotter layer number is k.

As described above, i and j may be the same. Therefore, the coefficient J_{i,j} is the amount representing the intensity of the interaction between the same or different spins existing in the same trotter layer. In quantum mechanics, a concept of an intensity of an interaction between the same spins exists. The intensity of the interaction is an index indicating a degree of overlapping of wave functions. The intensity of the interaction between the same spins is a value indicating that the overlapping of the wave functions completely matches.

A coefficient hᵢ is an amount representing a magnitude of energy of the spin itself of the spin number i. A coefficient of a third term on a right side of Formula (1) (hereinafter, referred to as “interlayer amount”) represents an intensity of an interaction between spins belonging to different trotter layers. The interlayer amount is also an amount representing an intensity of a transverse magnetic field in quantum annealing.

As described above, the Hamiltonian of the quantum annealing model is a Hamiltonian of a spin system during execution of the quantum annealing.

The optimization of the optimization target is specifically a process of obtaining a combination of eigenvalues of spin operators that minimize energy of the optimization target (that is, an eigenvalue of the optimization target having lowest level of the Hamiltonian). The eigenvalue of the spin operator is 1 or −1. Therefore, the spin operator in the Hamiltonian representing the optimization target in an optimization process may be treated as a scalar variable of 1 or −1.

A process of performing the optimization on the optimization target by performing the optimization on the Hamiltonian of the transverse magnetic field Ising model equivalent to the Ising model representing the optimization target by the stochastic calculation is specifically a stochastic optimization process.

The stochastic optimization process is a process of sequentially executing a series of formulas satisfying a state update condition, which is a condition related to an update of a spin state, one by one by the stochastic calculation until an optimization process end condition is satisfied. The optimization process end condition is a predetermined end condition related to an end of the optimization process. The execution of the formulas means a process of acquiring values indicated by the formulas.

Therefore, the stochastic optimization process is a process of sequentially executing a series of formulas satisfying update condition, which is the condition related to the update of the spin state, by the stochastic calculation until the predetermined end condition is satisfied. As a result of such a stochastic optimization process, the optimization target is optimized.

### <State Update Condition>

The state update condition includes a first condition, second condition, a a third condition, and a fourth condition. The first condition is a condition indicating the spin state. The second condition is a condition that represents a relationship between the spin states obtained at different times.

The third condition is a condition that represents a relationship between the adjacent trotter layers. The fourth condition is a condition that is an amount indicated by the Hamiltonian of the quantum annealing model and includes the coefficient J_{i,j}, the coefficient hᵢ, and the interlayer amount.

### <Trotter Layer>

The trotter layer, which will be further understood with the description using formulas described below, is a scalar function that appears by Suzuki-Trotter decomposition for a distribution function of the optimization target. More specifically, the trotter layers are first to m-th first type functions and first to m-th second type functions.

The m-th first type function is a result of executing a first type m-th Dirac process on a transverse magnetic field matrix exponential function. The transverse magnetic field matrix exponential function is an exponential mapping of a function obtained by multiplying a transverse magnetic field Hamiltonian by a reverse temperature, (−1), and the number of trotters. The transverse magnetic field Hamiltonian is a Hamiltonian included in the Hamiltonian of the quantum annealing model, and is a Hamiltonian representing an interaction between the transverse magnetic field and the spin.

The first type m-th Dirac process is a process of respectively applying, to the Hamiltonian to be processed, a (m+1)-th base vector and a m-th base vector in a predetermined complete orthonormal system, with the (m+1)-th base vector applied from left and the m-th base vector applied from right. The scalar function obtained as a result of the first type m-th Dirac process on the Hamiltonian included in the Hamiltonian of the quantum annealing model and representing the interaction between the transverse magnetic field and the spin is the m-th first type function.

m is an integer of 1 or more and M or less. M is the number of trotters. Therefore, M is a predetermined natural number, and m is the value indicating the position on the trotter axis. The trotter axis means a newly added one-dimensional direction when a dimension is expanded from d dimensions to d+1 dimensions by the Suzuki-Trotter decomposition. Since the first type m-th Dirac process is defined as described above, for example, a first type first Dirac process is a process of respectively applying, to a function to be processed, a first base vector and a second base vector in the predetermined complete orthonormal system, with the second base vector applied from left and the first base vector applied from right. In addition, for example, a first type fifth Dirac process is a process of respectively applying, to the function to be processed, a fifth base vector and a sixth base vector in the predetermined complete orthonormal system, with the sixth base vector applied from left, and the fifth base vector applied from right.

The m-th second type function is a result of executing a second type m-th Dirac process on the transverse magnetic field matrix exponential function. The second type m-th Dirac process is a process of respectively applying, to the Hamiltonian to be processed, the m-th base vector and the (m+1)-th base vector in the predetermined complete orthonormal system, with the m-th base vector applied from left, and the (m+1)-th base vector applied from right.

The scalar function obtained as a result of the second type m-th Dirac process on the Hamiltonian included in the Hamiltonian of the quantum annealing model and representing the interaction between the transverse magnetic field and the spin is the m-th second type function.

The predetermined complete orthonormal system is, for example, a complete orthonormal system spanned by eigenvectors of the spin operators included in the Hamiltonian of the quantum annealing model. Note that m and m+1 indicate an order in which operations are executed.

One lower trotter layer is a trotter layer in which the value of the trotter axis is smaller by one. One upper trotter layer is a trotter layer in which the value of the trotter axis is larger by one.

The combination of the eigenvalues of the spin operators at a time when the optimization process end condition is satisfied is a solution to an optimization problem. Since the optimization is a process of obtaining the solution to the optimization problem, the combination of the eigenvalues of the spin operators obtained by sequentially executing the formulas satisfying the state update condition until the optimization process end condition is satisfied is a result of the optimization of the optimization target.

### <Specific Example of Formula Satisfying State Update Condition>

The formulas satisfying the state update condition are, for example, represented by the following Formulas (2) to (4). Derivation of Formulas (2) to (4) requires many pages, and thus will be described later for good visibility of the description.

$$\begin{matrix}[ Math . 2 ] & \\ {I}_{i , k} ( t + 1 ) + {h}_{i} + {J}_{i , j} {σ}_{j , k} ( t ) + {J}_{⊥} {σ}_{i , k + 1} ( t - α ) + {n}_{rnd} \cdot {r}_{i} ( t ) & ( 2 )\end{matrix}$$

$$\begin{matrix}[ Math . 3 ] & \\ I {tanh}_{i , k} ( t + 1 ) = \{ \begin{matrix}{I}_{0} - 1 if I {tanh}_{i , k} ( t ) + {I}_{i , k} ( t + 1 ) \geq {I}_{0} \\ - {I}_{0} else if I {tanh}_{i , k} ( t ) + {I}_{i , k} ( t + 1 ) < - {I}_{0} \\ I {tanh}_{i , k} ( t ) + {I}_{i , k} ( t + 1 ) othewise\end{matrix} & ( 3 )\end{matrix}$$

$$\begin{matrix}[ Math . 4 ] & \\ {σ}_{i , k} ( t + 1 ) = \{ \begin{matrix}1 & if I {tanh}_{i , k} ( t + 1 ) \geq 0 \\ - 1 & otherwise\end{matrix} & ( 4 )\end{matrix}$$

Since Formulas (2) to (4) include the spin operator σ, Formulas (2) to (4) obviously satisfy the first condition described above. In addition, since Formulas (2) to (4) include the coefficient J_{i,j}, the coefficient hᵢ, and the interlayer amount, the fourth condition is satisfied.

An amount t in Formulas (2) to (4) is an integer of 0 or more. t indicates the number of times that processes of a set of Formulas (2) to (4) have already been executed. Therefore, t is an amount indicating the number of times the formulas satisfying the state update condition are executed. Therefore, for example, σ (t=0) indicates the value of the spin operator σ in an initial state. Hereinafter, a variable t is referred to as a time t. The time t is a specific example of the amount indicating the number of times in the second condition described above.

α represents a time lag. Therefore, a time t−α in Formula (2) represents a time earlier than the time t by the time α. α is a predetermined integer. Therefore, Formulas (2) to (4) including a fourth term on a right side of Formula (2) satisfy the second condition described above.

In Formulas (2) to (4), I tan h represents a state in a finite state machine (FSM) of the stochastic calculation. As a subscript of I tan h, i represents an index of an i-th spin of the trotter layer k. Note that m is k or more, and k is 1 or more. I₀ means the reverse temperature. A value of the reverse temperature is a predetermined value.

In Formulas (2) to (4), hᵢ means a bias applied to an input I_{i,k} to the FSM.

Formula (2) represents a relationship between a state I of the trotter layer number k and the spin σ of the trotter layer whose trotter layer number is (k+1) by a third term. Therefore, Formulas (2) to (4) satisfy the third condition described above. Therefore, Formulas (2) to (4) are examples of the formulas satisfying the state update condition.

A fifth term on the right side of Formula (2) (that is, n_{rnd}·rᵢ(t)) represents noise. In Formula (3), I tan hh_{i,k}(t+1) is an auxiliary variable defined by Formula (3). The value of σ (that is, the eigenvalue of the spin operator σ) is updated to the value shown in Formula (4) according to a rule shown in Formula (4) based on results of Formulas (2) and (3).

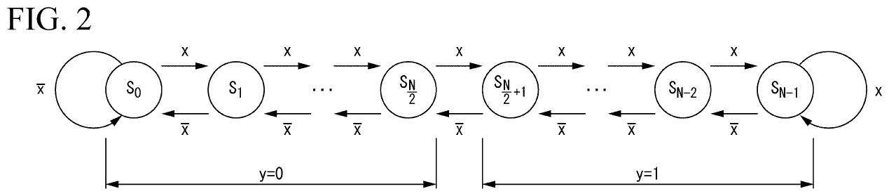

FIG. 2 is a diagram showing an example of the FSM according to the embodiment. FIG. 2 is a diagram showing an example of the FSM whose state is updated according to Formulas (2) to (4). In FIG. 2, a character x with an attached accent symbol (bar: −) means negation. Therefore, for example, the character x represents 1, and the character x with the attached accent symbol (bar: −) represents 0. In FIG. 2, y means an output. In FIG. 2, S means a state. A subscript of the state S represents the state. In FIG. 2, the number of states is N.

The optimization process end condition may be any condition as long as the condition relates to the end of the optimization process. The optimization process end condition may be, for example, a condition that the predetermined time t in Formulas (2) to (4) is reached. The optimization process end condition may be, for example, a condition that a change in energy of the optimization target due to the update of the solution to the optimization problem is smaller than a predetermined change.

<Relationship with Stochastic Calculation>

As described above, the optimization device 1 performs the optimization by the stochastic calculation instead of analog calculation or binary calculation. The stochastic calculation includes not only calculations used in the binary calculations such as addition, subtraction, multiplication, and division, but also calculations capable of executing the finite state machine. The formulas satisfying the state update conditions such as Formulas (2) to (4) are formulas indicating rules for updating the state in the FSM. Therefore, the optimization device 1 performs the optimization on the optimization target by performing the stochastic calculation for updating the state of the FSM according to the formula satisfying the state update condition. Specifically, the optimization is a process of obtaining a combination of values of the respective stochastic numbers representing the eigenvalues of the spin operators, which minimizes eigenvalues of the Hamiltonian.

As is well known, the stochastic calculation is a process executed by a classical computer.

<Relationship with Quantum Annealing>

The quantum annealing is an optimization technique using a quantum computer, and is a technique for implementing a state in which the minimum energy is provided as energy of a system of the optimization target by applying the transverse magnetic field. It is known that the quantum annealing implements the optimization in a short time. The optimization device 1 converts the Hamiltonian of the Ising model as the optimization target into the Hamiltonian of the spin system during the quantum annealing to which the transverse magnetic field is applied, and performs the optimization on the system of the Hamiltonian after the conversion. The optimization device 1 performs the optimization on the optimization target by the stochastic calculation using the formulas satisfying the state update condition, which are formulas obtained based on the Hamiltonian after the conversion and the formulas indicating the rule for updating the state in the FSM. The formulas satisfying the state update condition are formulas obtained by using a result obtained by converting the formula of the Hamiltonian after the conversion into a formula with one more dimension by the Suzuki-Trotter decomposition. The dimension increased by one is the dimension in a trotter axis direction.

As described above, the optimization device 1 executes the quantum annealing in a pseudo manner by the classical computer. When the classical computer executes pseudo execution of the quantum annealing, the optimization device 1 executes the above-described formulas satisfying the state update condition by the stochastic calculation. It can be said that the above-described formulas satisfying the state update condition are formulas representing a procedure of solving the combination of the eigenvalues of the spin operators that provide the minimum energy to the system in the state in which the transverse magnetic field is applied (that is, the spin system during the quantum annealing) by the stochastic calculation. As described above, the optimization device 1 does not simply execute the quantum annealing in the pseudo manner by the classical computer, but also performs the pseudo execution of the quantum annealing by the classical computer by the stochastic calculation.

Since the stochastic calculation is executed by the classical computer, it goes without saying that a cost required for mounting and operating the device in the optimization executed by the optimization device 1 is lower than that of the quantum computer.

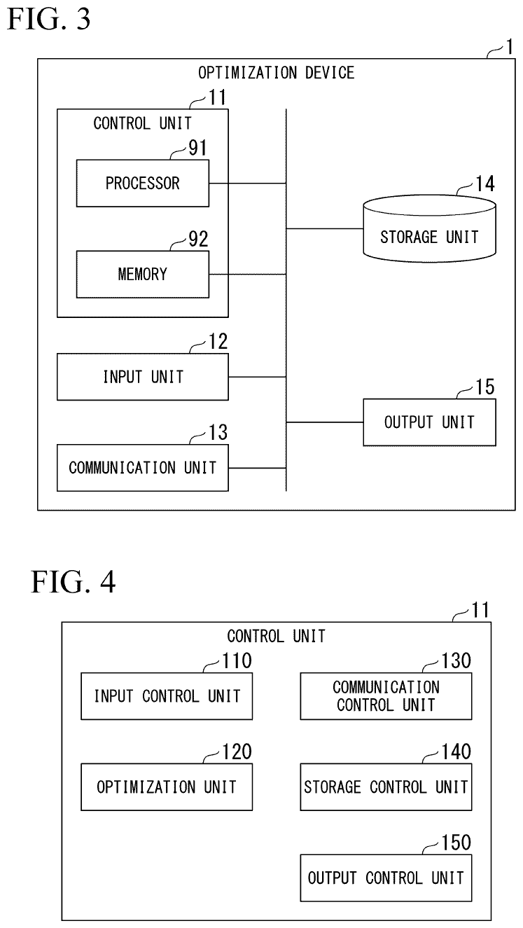

FIG. 3 is a diagram showing an example of a hardware configuration of the optimization device 1 according to the embodiment. The optimization device 1 includes a control unit 11 including a processor 91 such as a central processing unit (CPU) and a memory 92 connected by a bus, and executes a program. The optimization device 1 functions as a device including the control unit 11, an input unit 12, a communication unit 13, a storage unit 14, and an output unit 15 by executing the program.

More specifically, the processor 91 reads the program stored in the storage unit 14 and stores the read program in the memory 92. The processor 91 executes the program stored in the memory 92, so that the optimization device 1 functions as a device including the control unit 11, the input unit 12, the communication unit 13, the storage unit 14, and the output unit 15.

The control unit 11 controls operations of various functional units included in the optimization device 1. The control unit 11 performs the optimization on, for example, the optimization target. The control unit 11 controls, for example, an operation of the output unit 15. The control unit 11 records, for example, various types of information generated in the optimization in the storage unit 14. The control unit 11 records, for example, a result of the optimization in the storage unit 14.

The input unit 12 includes input devices such as a mouse, a keyboard, and a touch panel. The input unit 12 may be configured as an interface that connects these input devices to the optimization device 1. The input unit 12 receives input of various types of information to the optimization device 1.

The communication unit 13 includes a communication interface for connecting the optimization device 1 to an external device. The communication unit 13 communicates with the external device in a wired or wireless manner.

The storage unit 14 is implemented using a computer-readable storage medium device (non-transitory computer-readable recording medium) such as a magnetic hard disk device or a semiconductor storage device. The storage unit 14 stores various types of information related to the optimization device 1. The storage unit 14 stores, for example, information input via the input unit 12 or the communication unit 13. The storage unit 14 stores, for example, various types of information generated by the execution of the optimization.

The output unit 15 outputs various types of information. The output unit 15 includes a display device such as a cathode ray tube (CRT) display, a liquid crystal display, or an organic electro-luminescence (EL) display. The output unit 15 may be configured as an interface that connects these display devices to the optimization device 1. The output unit 15 outputs, for example, information input to the input unit 12. The output unit 15 may display, for example, a result of the optimization.

FIG. 4 is a diagram showing an example of a configuration of the control unit 11 included in the optimization device 1 according to the embodiment. The control unit 11 includes an input control unit 110, an optimization unit 120, a communication control unit 130, a storage control unit 140, and an output control unit 150.

The input control unit 110 controls an operation of the input unit 12.

The optimization unit 120 performs the optimization on the optimization target. That is, the optimization unit 120 performs the optimization by executing the stochastic optimization process. The optimization unit 120 may further execute a Hamiltonian conversion process. The Hamiltonian conversion process is a process of acquiring the Hamiltonian of the quantum annealing model based on the Hamiltonian representing the optimization target. The Hamiltonian conversion process is, for example, a process of adding a term of an interaction between a transverse magnetic field and a spin to a Hamiltonian of an optimization target. When the Hamiltonian conversion process is executed, the Hamiltonian conversion process is executed before the stochastic optimization process is executed. The Hamiltonian of the quantum annealing model is, for example, the Hamiltonian of Formula (5) described later.

When information indicating the Hamiltonian of the quantum annealing model is input to the input unit 12, the optimization unit 120 does not need to execute the Hamiltonian conversion process. When the Hamiltonian of the optimization target is input to the input unit 12, the optimization unit 120 executes the Hamiltonian conversion process.

The communication control unit 130 controls an operation of the communication unit 13. The storage control unit 140 records various types of information in the storage unit 14. The output control unit 150 controls an operation of the output unit 15.

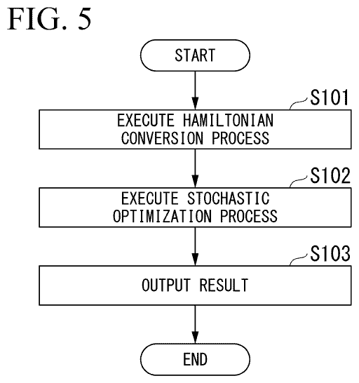

FIG. 5 is a flowchart showing an example of a flow of processing executed by the optimization device 1 according to the embodiment. More specifically, FIG. 5 is a flowchart showing an example of a flow of processing executed by the optimization device 1 when the optimization unit 120 also executes the Hamiltonian conversion process.

The optimization unit 120 executes the Hamiltonian conversion process (step S101). Next, the optimization unit 120 executes the stochastic optimization process (step S102). By executing step S102, the optimization of the optimization target is performed. Next, the output control unit 150 controls the operation of the output unit 15 to output the result of the optimization obtained by executing step S102 (step S103).

### <Description Using Formula of Trotter Layer>

The distribution function of the system of the transverse magnetic field Ising model represented by the Hamiltonian of the following Formulas (5) to (7) is derived.

$$\begin{matrix}[ Math . 5 ] & \\ H = {H}_{0} + {H}_{1} & ( 5 )\end{matrix}$$

$$\begin{matrix}[ Math . 6 ] & \\ {H}_{0} = - {\sum }_{i , j = 1}^{N} {J}_{i j} {σ}_{i}^{z} {σ}_{j}^{z} - {\sum }_{i = 1}^{B} {h}_{i} {σ}_{i}^{z} & ( 6 )\end{matrix}$$

$$\begin{matrix}[ Math . 7 ] & \\ {H}_{1} = - Γ {\sum }_{i = 1}^{N} {σ}_{i}^{x} & ( 7 )\end{matrix}$$

In Formula (7), Γ represents the magnitude of the transverse magnetic field. Therefore, Γ is the same as the interlayer amount. The Hamiltonian represented by Formula (7) is an example of the transverse magnetic field Hamiltonian. Formula (7) represents the same mathematical phenomenon as the third term on the right side of Formula (1). This is indicated by converting a Pauli spin matrix ix into spins i, m, 1, and m+1 by processing of Formulas (10) to (28) described later including Suzuki-Trotter decomposition. Further, −i=1Nix is converted into Ji=1Nk=1 Mi, ki, k+1, so that there is no transverse magnetic field that cannot be classically calculated. Instead, one dimension is added, and an Ising model having a dimension corresponding to a transverse magnetic field of a classical system is generated. A superscript of the spin operator σ indicates that x is a spin operator of an x component of the Pauli matrix and z is a spin operator of a z component of the Pauli matrix. That is, each spin operator is defined by the following Formulas (8) and (9). Hereinafter, a hat symbol is attached to a symbol indicating an operator in order to emphasize the operator.

$$\begin{matrix}[ Math . 8 ] & \\ {\hat{σ}}^{x} = [ \begin{matrix}0 & 1 \\ 1 & 0\end{matrix} ] & ( 8 )\end{matrix}$$

$$\begin{matrix}[ Math . 9 ] & \\ {\hat{σ}}^{z} = [ \begin{matrix}0 & 1 \\ 1 & 0\end{matrix} ] & ( 9 )\end{matrix}$$

The distribution function of the system of the transverse magnetic field Ising model represented by the Hamiltonian of Formulas (5) to (7) is represented by the following Formula (10).

$$\begin{matrix}[ Math . 10 ] & \\ Z = {lim}_{M \to ∞} {\sum }_{{\hat{σ}}_{1}^{z}} 〈 {\hat{σ}}_{1}^{z} \vert {( {e}^{- \frac{{I}_{0}}{M} {H}_{0}} \cdot {e}^{- \frac{{I}_{0}}{M} {H}_{1}} )}^{M} \vert {\hat{σ}}_{1}^{z} 〉 & ( 10 )\end{matrix}$$

The Hamiltonian of Formula (10) is subjected to the formula modification.

$$\begin{matrix}[ Math . 11 ] & \\ Z = {lim}_{M \to ∞} {\sum }_{{\hat{σ}}_{1}^{z}} 〈 {\hat{σ}}_{1}^{z} \vert ABABAB … AB \vert {\hat{σ}}_{1}^{z} 〉 & ( 11 )\end{matrix}$$

$$\begin{matrix}[ Math . 12 ] & \\ A = {e}^{- \frac{{I}_{0}}{M} {H}_{0}} & ( 12 )\end{matrix}$$

$$\begin{matrix}[ Math . 13 ] & \\ B = {e}^{- \frac{{I}_{0}}{M} {H}_{1}} & ( 13 )\end{matrix}$$

I₀ represents a reverse temperature. The value of the reverse temperature is a predetermined value. In Formula (11), there are M sets of AB. Next, formula modification using a condition indicating a completeness relation of spin operators represented by the following Formula (14) is performed.

$$\begin{matrix}[ Math . 14 ] & \\ \vert {\hat{σ}}_{k}^{z} 〉 〈 {\hat{σ}}_{k}^{z} \vert = I & ( 14 )\end{matrix}$$

$$\begin{matrix}[ Math . 15 ] & \\ Z = {lim}_{M \to ∞} {\sum }_{{\hat{σ}}_{1}^{z}} 〈 {\hat{σ}}_{1}^{z} \vert AIBIAIBIAIBI … IAIB \vert {\hat{σ}}_{1}^{z} 〉 & ( 15 )\end{matrix}$$

$$\begin{matrix}[ Math . 16 ] & \\ & ( 16 )\end{matrix}$$

$$Z = {lim}_{M \to ∞} {\sum }_{{\hat{σ}}_{1}^{z}} 〈 {\hat{σ}}_{1}^{z} \vert {e}^{- \frac{{I}_{0}}{M} {H}_{0}} \vert {\hat{σ}}_{1}^{z} 〉 〈 {\hat{σ}}_{1}^{z} \vert {e}^{- \frac{{I}_{0}}{M} {H}_{1}} \vert {\hat{σ}}_{2}^{z} 〉 〈 {\hat{σ}}_{2}^{z} \vert {e}^{- \frac{{I}_{0}}{M} {H}_{0}} \vert {\hat{σ}}_{2}^{z} 〉 〈 {\hat{σ}}_{2}^{z} \vert {e}^{- \frac{{I}_{0}}{M} {H}_{1}} \vert {\hat{σ}}_{3}^{z} 〉$$

$$⋮$$

$$〈 {\hat{σ}}_{M}^{z} \vert {e}^{- \frac{{I}_{0}}{M} {H}_{0}} \vert {\hat{σ}}_{M}^{z} 〉 〈 {\hat{σ}}_{M}^{z} \vert {e}^{- \frac{{I}_{0}}{M} {H}_{1}} \vert {\hat{σ}}_{1}^{z} 〉$$

Next, the Suzuki-Trotter decomposition is performed. By the Suzuki-Trotter decomposition, the distribution function represented by Formula (16) is converted into the following Formula (17).

$$\begin{matrix}[ Math . 17 ] & \\ & ( 17 )\end{matrix}$$

$$Z = {lim}_{M \to ∞} {\sum }_{{\hat{σ}}_{i}^{z}} 〈 {\hat{σ}}_{1}^{z} \vert {e}^{- \frac{{I}_{0}}{2 M} {H}_{0}} \vert {\hat{σ}}_{1}^{z} 〉 〈 {\hat{σ}}_{1}^{z} \vert {e}^{- \frac{{I}_{0}}{2 M} {H}_{1}} \vert {\hat{σ}}_{2}^{z} 〉 〈 {\hat{σ}}_{2}^{z} \vert {e}^{- \frac{{I}_{0}}{2 M} {H}_{0}} \vert {\hat{σ}}_{2}^{z} 〉 〈 {\hat{σ}}_{2}^{z} \vert {e}^{- \frac{{I}_{0}}{2 M} {H}_{1}} \vert {\hat{σ}}_{3}^{z} 〉$$

$$⋮$$

$$〈 {\hat{σ}}_{M}^{z} \vert {e}^{- \frac{{I}_{0}}{2 M} {H}_{0}} \vert {\hat{σ}}_{M}^{z} 〉 〈 {\hat{σ}}_{M}^{z} \vert {e}^{- \frac{{I}_{0}}{2 M} {H}_{1}} \vert {\hat{σ}}_{1}^{z} 〉 〈 {\hat{σ}}_{1}^{z} \vert {e}^{- \frac{{I}_{0}}{2 M} {H}_{0}} \vert {\hat{σ}}_{1}^{z} 〉 〈 {\hat{σ}}_{1}^{z} \vert {e}^{- \frac{{I}_{0}}{2 M} {H}_{1}} \vert {\hat{σ}}_{M}^{z} 〉$$

$$⋮$$

$$〈 {\hat{σ}}_{3}^{z} \vert {e}^{- \frac{{I}_{0}}{2 M} {H}_{1}} \vert {\hat{σ}}_{2}^{z} 〉 〈 {\hat{σ}}_{2}^{z} \vert {e}^{- \frac{{I}_{0}}{2 M} {H}_{0}} \vert {\hat{σ}}_{2}^{z} 〉 〈 {\hat{σ}}_{2}^{z} \vert {e}^{- \frac{{I}_{0}}{2 M} {H}_{1}} \vert {\hat{σ}}_{1}^{z} 〉$$

The function represented by the following Formula (18) included in Formula (17) is a specific example of the m-th first type function.

$$\begin{matrix}[ Math . 18 ] & \\ 〈 {\hat{σ}}_{m + 1}^{z} \vert {e}^{- \frac{{I}_{0}}{M} {H}_{1}} \vert {\hat{σ}}_{m}^{z} 〉 & ( 18 )\end{matrix}$$

The function represented by the following Formula (19) included in Formula (17) is a specific example of the m-th second type function.

$$\begin{matrix}[ Math . 19 ] & \\ 〈 {\hat{σ}}_{m}^{z} \vert {e}^{- \frac{{I}_{0}}{M} {H}_{1}} \vert {\hat{σ}}_{m + 1}^{z} 〉 & ( 19 )\end{matrix}$$

As described above, a symbol representing the trotter layer is m. The trotter layer is the amount derived in this manner.

Formula (18) represents interference from an m-th trotter layer to a (m+1)-th trotter layer. Formula (19) represents interference from the (m+1)-th trotter layer to the m-th trotter layer. The interference from the (m+1)-th trotter layer to the m-th trotter layer means an interaction that causes the spins 1, m to N, and m of the m-th trotter layer to be in the same direction as spins of the (m+1)-th trotter layer existing at the same positions (1 to N).

Further, a process of deriving Formula (1) will be described. Here, a transfer matrix will be described. By using the transfer matrix, exp (Bσₖσₖ₊₁) can be converted into a 2×2 matrix. A value of σₖσₖ₊₁ is +1 or −1. σₖσₖ₊₁ satisfies a relationship of the following Formula (20).

$$\begin{matrix}[ Math . 20 ] & \\ \{ {σ}_{k} , {σ}_{k + 1} \} = [ \begin{matrix}\{ + 1 , + 1 \} & \{ - 1 , + 1 \} \\ \{ + 1 , - 1 \} & \{ - 1 , - 1 \}\end{matrix} ] & ( 20 )\end{matrix}$$

By using the transfer matrix, exp (Bσₖσₖ₊₁) is represented by the following Formula (21).

$$\begin{matrix}[ Math . 21 ] & \\ exp ( B {σ}_{k} {σ}_{k + 1} ) = [ \begin{matrix}{e}^{B} & {e}^{- B} \\ {e}^{- B} & {e}^{B}\end{matrix} ] = {e}^{B} [ \begin{matrix}1 & {e}^{- 2 B} \\ {e}^{- 2 B} & 1\end{matrix} ] & ( 21 )\end{matrix}$$

Next, the following Formula (22) is substituted into the Formula (19) to perform Maclaurin expansion. The following formula (23) represents a process and results of the Maclaurin expansion. Note that, in the following formula modification, (I₀Γ)/M is replaced with A for ease of understanding of the formula modification.

$$\begin{matrix}[ Math . 22 ] & \\ {H}_{1} = - Γ {\sum }_{i = 1}^{N} {\hat{σ}}_{i}^{x} & ( 22 )\end{matrix}$$

$$\begin{matrix}[ Math . 23 ] & \\ \begin{matrix}exp ( \frac{{I}_{0} Γ}{M} {\hat{σ}}_{i}^{x} ) = {\sum }_{k} {( \frac{{I}_{0} Γ}{M} )}^{k} \frac{1}{k !} {( {\hat{σ}}_{i}^{x} )}^{k} = I ( 1 + \frac{{A}^{2}}{2 !} + \frac{{A}^{4}}{4 !} … ) + \\ {\hat{σ}}_{i}^{x} ( A + \frac{{A}^{3}}{3 !} + \frac{{A}^{5}}{5 !} … ) \\ = I cosh ( A ) + {\hat{σ}}_{i}^{x} sinh ( A ) \\ = cosh ( A ) [ \begin{matrix}1 & tanh ( A ) \\ tanh ( A ) & 1\end{matrix} ] \\ = cosh ( A ) [ \begin{matrix}1 & {e}^{- 2 B} \\ {e}^{- 2 B} & 1\end{matrix} ]\end{matrix} & ( 23 )\end{matrix}$$

Here, when tan h (A)=exp(−2B) is replaced using the above-described transfer matrix, the following Formula (24) is derived.

$$\begin{matrix}[ Math . 24 ] & \\ exp ( \frac{{I}_{0} Γ}{M} {\hat{σ}}_{i}^{x} ) = cosh ( A ) {e}^{- B} exp ( B {σ}_{i , k} {σ}_{i , k + 1} ) & ( 24 )\end{matrix}$$

In this manner, sigma or a term of the transverse magnetic field −i=1Nix was transformed into a classical system using σᵢ, kσi, and k+1.

If Formula (24) is used, the following Formula (25) is derived.

$$\begin{matrix}[ Math . 25 ] & \\ H = - {\sum }_{i , j = 1}^{N} {\sum }_{k = 1}^{M} \frac{{J}_{i , j}}{M} {σ}_{i , k} {σ}_{j , k} - {\sum }_{i = 1}^{N} {\sum }_{k = 1}^{M} \frac{{h}_{i}}{M} {σ}_{i , k} - {J}_{⊥} {\sum }_{i = 1}^{N} {\sum }_{k = 1}^{M} {σ}_{i , k} {σ}_{i , k + 1} & ( 25 )\end{matrix}$$

In Formula (25), Formula (1) is obtained by using a relationship of the following Formula (26).

### <Derivation of Formula Satisfying State Update Condition>

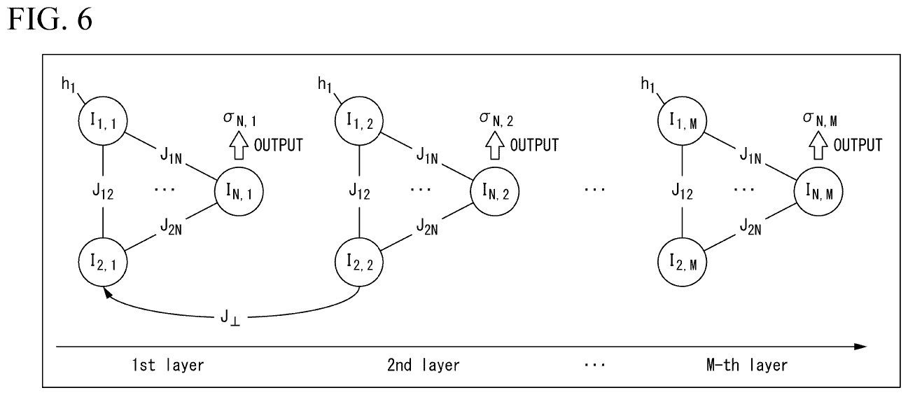

FIG. 6 is a diagram showing an example of the Ising model according to the embodiment. In FIG. 6, “layer” means the trotter layer. Therefore, in FIG. 6, “1st layer” means a trotter layer of k=1, “2nd layer” means a trotter layer of k=2, and “M-th layer” means a trotter layer of k=M. In FIG. 6, I means a state. In FIG. 6, h is applied to only one state for each layer, but this is for ease of viewing of the drawing, and h is applied to all states.

The Ising model in FIG. 6 is an Ising model indicated by the Hamiltonian of Formula (1). Therefore, based on the Ising model in FIG. 6, an example of a formula for updating the spin state of the Hamiltonian of Formula (1) in the stochastic calculation is the following Formula (26).

$$\begin{matrix}[ Math . 26 ] & \\ {I}_{i , k} ( t + 1 ) = tanh ( {I}_{0} \cdot ( {h}_{i} + {J}_{i , j} {σ}_{j , k} ( t ) + {J}_{⊥} {σ}_{i , k + 1} ( t - α ) ) + {n}_{rnd} \cdot {r}_{i} ( t ) ) & ( 26 )\end{matrix}$$

$${σ}_{i , k} ( t + 1 ) = \{ \begin{matrix}1 & if {I}_{i , k} ( t + 1 ) \geq 0 \\ - 1 & otherwise\end{matrix}$$

Based on a theory of the stochastic calculation, the tan h function is approximated by a Stanh function. Based on the theory of the stochastic calculation, Formula (26) is converted into Formulas (2) to (4) using an up-down counter in FIG. 2 in which the state stochastically transitions. Approximating the tan h function by the Stanh function specifically means using a relationship represented by the following Formula (27).

$$\begin{matrix}[ Math . 27 ] & \\ S tanh ( N , x ) \approx tanh ( x \cdot N / 2 ) & ( 27 )\end{matrix}$$

Formula (2) is similar to the following Formula (28). This is because Q in Formula (28) represents the intensity of the transverse magnetic field, and rnd (−1, +1) in Formula (28) means a random number.

$$\begin{matrix}[ Math . 28 ] & \\ {I}_{i , k} ( t + 1 ) = {h}_{i ,} + {J}_{i , j} {m}_{j , k} ( t ) + Q ( t ) {m}_{i , k - 1} ( t - α ) + r n d ( - 1 , + 1 ) & ( 28 )\end{matrix}$$

### <Experimental Results>

A low cost of optimization implemented by the optimization device 1 was also confirmed in experiments. Therefore, an example of experimental results will be introduced. In the experiments, Formulas (2) to (4) were used as the formulas satisfying the state update condition. Further, the optimization target used in the experiment was represented by the Ising model, and the Hamiltonian of the transverse magnetic field Ising model equivalent to this Ising model was the Hamiltonian of Formula (1). In the experiment, an average processing time required to obtain an optimal solution was evaluated.

### <Experimental Results>

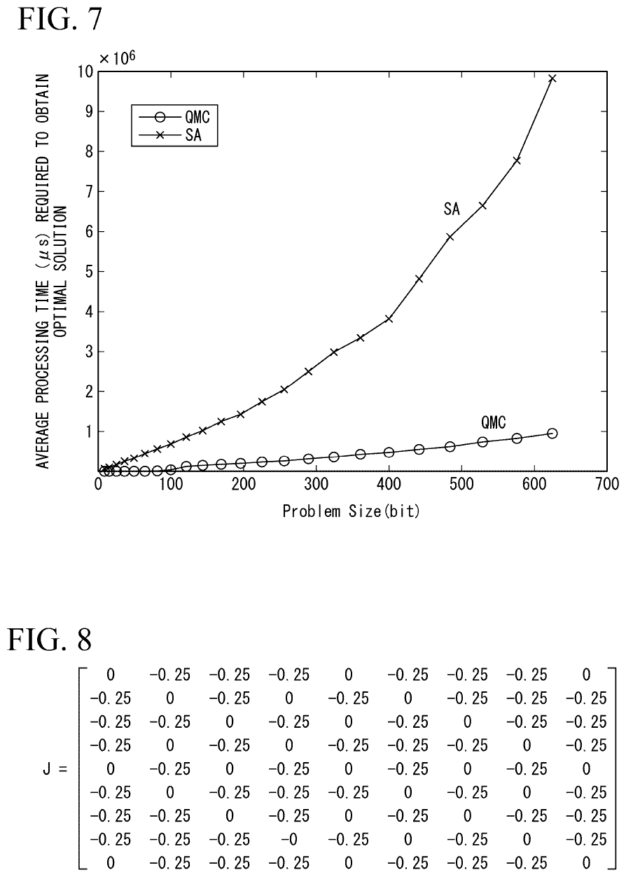

FIG. 7 is a diagram showing an example of a result of an experiment using the optimization device 1 according to the embodiment. In the experiment, as a comparison target, the optimization of the optimization target was performed by executing simulated annealing (SA) by stochastic calculation. In FIG. 7, a result of “SA” indicates the result of the optimization by the technique of the comparison target. In FIG. 7, a result of “QMC” represents the result of the optimization of the optimization target by the optimization device 1 executing the formulas satisfying the state update conditions represented by Formulas (2) to (4).

A horizontal axis in FIG. 7 represents a problem size. A unit of the horizontal axis in FIG. 7 is bit. The problem size is the number of spins. Therefore, for example, a problem size of 500 bits means that the number of spins is 500 (500 bits). A vertical axis in FIG. 7 represents the average processing time required to obtain the optimal solution. The number of trials for averaging was 100. A unit of the vertical axis in FIG. 7 is microseconds.

Specifically, the SA performed by the stochastic calculation of the comparison target was calculation described in PTL 1 below.

PTL 1: Naoya Onizawa, et al., “Fast-Converging Simulated Annealing for Ising Models Based on Integral Stochastic Computing”, IEEE TRANSACTIONS ON NEURAL NETWORKS AND LEARNING SYSTEMS, 2022. (in press) doi: 10.1109/TNNLS. 2022.3159713

In the experiment, a node number N was 3 to 25. The node number is a square root of the number of spins in the Ising model in FIG. 6 or the like.

In FIG. 7, a horizontal axis represents the problem size and a vertical axis represents a processing time of the annealing, and both a white circle and a cross mark represent results of the node numbers N=3 to 25 in order from left.

In the experiment, the value of the coefficient J_{i,j} was −0.25 to 0.00, and the value of the coefficient hᵢ was a random value within a range of −0.5 to −83.5. As long as the value of the coefficient hᵢ was within the range of −0.5 to −83.5, the experimental results were substantially the same as the results shown in FIG. 7 regardless of a combination of the values of the coefficient hᵢ.

The value of the coefficient of the third term on the right side of Formula (1) was 0.0 to 0.5, the value of x in Formula (2) was 1, the value of the reverse temperature was 2.0, the maximum value of i and j in Formulas (1) to (4) was a square of the node number N, the minimum value of k in Formulas (1) to (4) was 1, and the maximum value of k in Formulas (1) to (4) was the number of trotter layers M. In the experiment, a timing at which a search for the minimum energy was achieved was determined as a timing of the optimization. In the experiment, initial conditions were random.

The results in FIG. 7 indicates that a time required for the optimization performed by the optimization device 1 is shorter than that of the technique of the comparison target. That is, the optimization device 1 requires less cost for the optimization than the technique of the comparison target.

FIG. 8 is a diagram showing the coefficient J_{i,j} used in the experiment in the embodiment. More specifically, FIG. 8 is a diagram showing the coefficient J_{i,j} in the experiment in which the experimental result in FIG. 7 is obtained. A value of an element in an i-th row and a j-th column of the matrix shown in FIG. 8 indicates the value of the coefficient J_{i,j}. Therefore, as described above, in the experiment, the value of the coefficient J_{i,j} was −0.25 to 0.00.

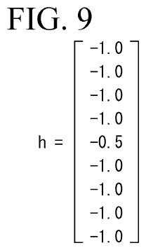

FIG. 9 is a diagram showing an example of the coefficient hᵢ used in the experiment in the embodiment. More specifically, FIG. 9 is a diagram showing an example of the coefficient hᵢ used in the experiment for obtaining the experimental result in FIG. 7. A value of an element in the i-th row of a vector shown in FIG. 9 indicates the value of the coefficient hᵢ. The example in FIG. 9 shows the coefficient hᵢ when the node number is 3.

The optimization device 1 having the configuration as described above executes the sequentially formula satisfying the state update condition by the stochastic calculation until a predetermined end condition regarding an end of the optimization processing is satisfied. Therefore, as described in the above <Effects of Optimization Device 1>, it is possible to reduce the cost required for optimization by the classical computer.

### (Modification)

The optimization device 1 may be implemented using a plurality of information processing apparatuses communicably connected via a network. In this case, each functional unit included in the optimization device 1 may be distributed and implemented in the plurality of information processing apparatuses.

All or some of the functions of the optimization device 1 may be implemented using hardware such as an application specific integrated circuit (ASIC), a programmable logic device (PLD), or a field programmable gate array (FPGA). The program may be recorded on a computer-readable recording medium. The “computer-readable recording medium” refers to a storage device, for example, a portable medium such as a flexible disk, a magneto-optical disk, a ROM, and a CD-ROM, and a hard disk built in the computer system. The program may be transmitted via an electric communication line.

As described above, the embodiment of the invention has been described in detail with reference to the drawings, specific configurations are not limited to the embodiment, and designs and the like within a range not departing from the gist of the present invention are also included.

### REFERENCE SIGNS LIST

1: optimization device
11: control unit
12: input unit
13: communication unit
14: storage unit
15: output unit
110: input control unit
120: optimization unit
130: communication control unit
140: storage control unit
150: output control unit
91: processor
92: memory

1. An optimization device, comprising:
a first processor; and
a first storage medium having computer program instructions stored thereon, wherein the computer program instruction, when executed by the first processor, perform processing of:
performing optimization, by stochastic calculation, on an optimization target by performing optimization on a Hamiltonian of a quantum annealing model, which is an Ising model representing the optimization target in a state in which a transverse magnetic field is applied, wherein
performing the optimization by sequentially executing a series of formulas satisfying a state update condition, which is a condition related to an update of a spin state, one by one by the stochastic calculation until a predetermined end condition is satisfied, and
the state update condition includes a first condition representing the spin state, a second condition representing a relationship between the spin states obtained at different times, a third condition representing a relationship between adjacent trotter layers, and a fourth condition including an amount representing an intensity of an interaction between the same or different spins existing in the same trotter layer, an amount representing a magnitude of energy of a spin itself, and an amount representing an intensity of an interaction between spins belonging to different trotter layers.

2. The optimization device according to claim 1, wherein,
the quantum annealing model is represented by Formula (1) below, and the series of formulas satisfying the state update condition are represented by Formulas (2), (3), and (4) below, and
J_{i,j} represents an intensity of an interaction between the same or different spins existing in a trotter layer whose trotter layer number is k, hᵢ represents the amount representing the magnitude of the energy of the spin itself, an interlayer amount which is a coefficient of a third term of a right side of Formula (1) represents the intensity of the interaction between the spins belonging to the different trotter layers, i and j are identifiers for distinguishing the spins, N is the number of spins existing in one trotter layer, t represents the number of times, t−α represents the number of times earlier than t by α, n_{md}·rᵢ(t) represents noise, and I₀ represents a reverse temperature.
$$\begin{matrix}[ Formula 1 ] & \\ H = - {\sum }_{i , j = 1}^{N} {J}_{i , j} {σ}_{i , k} {σ}_{j , k} - {\sum }_{i = 1}^{N} {h}_{i} {σ}_{i , k} - {J}_{⊥} {\sum }_{i = 1}^{N} {\sum }_{k = 1}^{M} {σ}_{i , k} {σ}_{i , k + 1} & ( 1 )\end{matrix}$$
$$\begin{matrix}[ Formula 2 ] & \\ {I}_{i , k} ( t + 1 ) = {h}_{i} + {J}_{i , j} {σ}_{j , k} ( t ) + {J}_{⊥} {σ}_{i , k + 1} ( t - α ) + {n}_{rnd} \cdot {r}_{i} ( t ) & ( 2 )\end{matrix}$$
$$\begin{matrix}[ Formula 3 ] & \\ I {tanh}_{i , k} ( t + 1 ) = \{ \begin{matrix}{I}_{0} - 1 if I {tanh}_{i , k} ( t ) + {I}_{i , k} ( t + 1 ) \geq {I}_{0} \\ - {I}_{0} else if I {tanh}_{i , k} ( t ) + {I}_{i , k} ( t + 1 ) < - {I}_{0} \\ I {tanh}_{i , k} ( t ) + {I}_{i , k} ( t + 1 ) otherwise\end{matrix} & ( 3 )\end{matrix}$$
$$\begin{matrix}[ Formula 4 ] & \\ {σ}_{i , k} ( t + 1 ) = \{ \begin{matrix}1 & if I {tanh}_{i , k} ( t + 1 ) \geq 0 \\ - 1 & otherwise\end{matrix} & ( 4 )\end{matrix}$$

3. An optimization method, comprising:
performing optimization on an optimization target by performing optimization on a Hamiltonian of a quantum annealing model, which is an Ising model representing the optimization target in a state in which a transverse magnetic field is applied, by a stochastic calculation, wherein:
the optimization is performed by sequentially executing a series of formulas satisfying a state update condition, which is a condition related to an update of a spin state, one by one by the stochastic calculation until a predetermined end condition is satisfied, and
the state update condition includes a first condition representing the spin state, a second condition representing a relationship between the spin states obtained at different times, a third condition representing a relationship between adjacent trotter layers, and a fourth condition including an amount representing an intensity of an interaction between the same or different spins existing in the same trotter layer, an amount representing a magnitude of energy of a spin itself, and an amount representing an intensity of an interaction between spins belonging to different trotter layers.

4. A non-transitory computer readable medium which stores a program configured to cause a computer to function as the optimization device according to claim 1.
